(19) United States
(12) Patent Application Publication
(10) Pub. No.: US 2016/0132535 A1
(43) Pub. Date: May 12, 2016

(54) ACCELERATION METHOD FOR DATABASE USING INDEX VALUE OPERATION AND MIXED-MODE LEVELED CACHE

(71) Applicant: NATIONAL APPLIED RESEARCH LABORATORIES, TAIPEI CITY (TW)

(72) Inventors: YU-JUNG CHENG, HSINCHU CITY (TW); YUN-TE LIN, HSINCHU CITY (TW); YUNG-HSIANG HUANG, HSINCHU CITY (TW); MING-TE TSAI, HSINCHU CITY (TW); YI-HAO HSIAO, HSINCHU CITY (TW); FANG-PANG LIN, HSINCHU CITY (TW)

(21) Appl. No.: 14/808,131

(22) Filed: Jul. 24, 2015

(30) Foreign Application Priority Data
Nov. 6, 2014 (TW) 103138558

(51) Int. Cl. G06F 17/30

(52) U.S. Cl. CPC G06F 17/30289; G06F 17/3033; G06F 17/3048

(57) ABSTRACT

The present invention provides an acceleration method for database using index value operation and mixed-mode leveled cache. While building a database, an algorithm is adopted for operating a plurality of field conditions and giving an index value. At least a file record in the database satisfying the plurality of field conditions is related to the index value. While querying, the input plurality of field conditions are operated using the algorithm, giving the index value. According to the index value, the file records in the database satisfying the plurality of field conditions are listed. Thereby, the time for comparing the plurality of fields can be saved.

### FIELD OF THE INVENTION

The present invention relates generally to an acceleration method for database using index value operation and mixed-mode leveled cache, and particularly to a method for accelerating queries by operating a plurality of field conditions in a mixed mode to give index values and thus facilitating access to the file records satisfying the field conditions rapidly during the query process, and for building pyramidal multi-level cache via memory or data table and thus the field conditions (or index values) in respective cache levels ever queried before are queried first during the query process.

### BACKGROUND OF THE INVENTION

The structured query language (SQL) is a rapid and convenient program language enabling users to perform various operations on the data in a relational database system using simple instructions. Although the SQL has no graphical interface, relational database systems having different bottom-level structures can use the SQL as the interface for data registering and management. For example, in the database systems Microsoft Access, Microsoft SQL Server, and Oracle, in addition to inserting graphic or audio files into the object linking and embedded (OLE) objects of database without compiling by using the OLE mechanism, all data in the database will be compiled and various data operations can be performed using SQL instructions.

The topmost level of a database structure is formed by data tables. A database can include multiple data tables. As implied by the name, a data table is a table storing data and is gathered by multiple records. Each record is formed by a group of relational fields. Each field stores a data entry. These data record a variety of messages such as text, number, date, or Boolean values according to a certain structural standard for describing the property of each record.

When a user queries in a database using multiple filed conditions, the database has to undergo multiple comparisons of the field conditions for giving the data record satisfying the field conditions assigned by the user. Multiple comparisons of field conditions consume substantial database performance and thus lowering the query efficiency.

Accordingly, the present invention provides a method for building database. Use an algorithm to operate multiple fields for generating the index values. For example, a hash algorithm, the message-digest algorithm 5 (MD5), is adopted for operating the field conditions and giving a universally unique identifier (UUID). Then the UUID is used as the index value. The index value given by operation can be used as new field data of file record. While querying, use the same algorithm to operate the input field conditions and give index values, which are next used to search the file records having relationship with the index values in the database. Thereby, the relationship among multiple data tables in the database can be accelerated. Besides, the performance and time can be improved compared to comparing multiple fields individually.

Furthermore, the present invention provides a method for building database. The field conditions used in past queries and the file records satisfying the field conditions are used as cache records and stored in multiple cache levels having different data storage capacity, respectively. When a query using an identical field condition is performed, the cache record in the cache level is retrieved for shortening the query time. In addition, while searching cache records in multiple cache levels, the order of search is from the cache level having the lowest data storage capacity to the one having the largest (pyramidal multi-level cache); an appropriate cache record replacement policy, for example, the round-robin queue algorithm, the least recently used (LRU) algorithm, and the least frequently used (LFU) algorithm, is also adopted. The cache records having frequent queries or close query times are arranged to be stored in the cache levels having lower data storage capacity. Thereby, the efficiency of retrieving cache records can be enhanced.

In order to prevent the racing condition while replacing cache records, according to the present invention, the global lock or individual lock technique can be adopted for locking the cache records stored in the cache levels and thus arranging and utilizing appropriately the data storage capacity in the cache levels. The global lock technique is simpler in operation at the expense of the overall operating efficiency. The individual lock technique is more complicated. However, its overall operating efficiency is higher.

### SUMMARY

An objective of the present invention is to provide a method for building database. A plurality of field conditions are mixed and operated for generating index values. By using the index values, the speed of searching the file records satisfying the field conditions can be accelerated.

Another objective of the present invention is to provide a method for querying in a database. A plurality of field conditions input during query are mixed and operated for generating index values. The file records satisfying the field conditions can be searched rapidly in the database by using the index values having built relationship with the filed records satisfying the field conditions. Thereby, the time and performance required for comparing a plurality of field conditions can be saved and improved.

Still another objective of the present invention is to provide a method for building database. The queried field conditions and the file records satisfying the field conditions are regarded as cache records and stored in the pyramidal multi-level cache. Thereby, the file records satisfying the field conditions can be retrieved rapidly from the database.

Another objective of the present invention is to provide a method for querying in a database. While retrieving the past query results, which are stored as cache records, from the pyramidal multi-level caches, the search order is from the cache level having smaller data storage capacity to that having larger data storage capacity. Thereby, the performance of retrieving the query results can be improved.

In order to achieve the objectives and efficacies as described above, the present invention discloses a method for building database. While building a database, an algorithm is used for operating a plurality of field conditions and giving an index value. Then at least a file record in the database satisfying the plurality of field conditions is made to be related to the index value. The index value can be used as a new field of the file record.

The present invention further discloses a method for querying in a database applicable to building a database according to the above method. When a user inputs a plurality of field conditions for querying in the database, an algorithm identical to the one used in the previous method is adopted for operating the plurality of field conditions and giving an index value. Then at least a file record related to the index value is retrieved from the database.

The present invention further discloses a method for building database. While building a database, a first cache level and a second cache level having greater data storage capacity than the first cache level are built. Besides, a plurality of past query records, each query record including a plurality of field conditions and at least a file record satisfying the plurality of field conditions, are stored as a plurality of cache records in the first or second cache level, respectively.

The present invention discloses a method for querying in a database and applicable to the method for building a database as described above. When a user queries the database by inputting a plurality of field conditions, a cache record corresponding to the plurality of field conditions is first retrieved from the database and a first cache level having the least data storage capacity is searched first. If the cache record is not stored in the first cache level, the cache record is next searched in a second cache level having greater data storage capacity than the first cache level.

### BRIEF DESCRIPTION OF THE DRAWINGS

FIG. 1A shows a flowchart for building database according to a preferred embodiment of the present invention;

FIG. 1B shows a structural schematic diagram of the database according to a preferred embodiment of the present invention;

FIG. 1C shows a flowchart for querying in a database according to a preferred embodiment of the present invention;

FIG. 2A shows a flowchart for building database according to another preferred embodiment of the present invention;

FIG. 2B shows a structural schematic diagram of the database according to another preferred embodiment of the present invention;

FIG. 2C shows a flowchart for querying in a database according to another preferred embodiment of the present invention; and

FIG. 3 shows a structural schematic diagram of the database according to still another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present provides an acceleration method for database using index value operation and mixed-mode leveled cache and owns two features. First, while building a database, an algorithm is used for mixing and operating a plurality of field conditions and generating index values. The index values are then made to be related to the file records satisfying the plurality of field conditions. Thereby, while querying the database using a plurality of field conditions, the same algorithm is adopted for operating the input field conditions and giving index values. The index values can be used for searching the file records satisfying the field conditions rapidly, and thus saving the time required to compare a plurality of field conditions and improving performance. Secondly, the present invention builds a pyramidal multi-level cache having different data storage capacity. In addition, the cache level having smaller data storage capacity is searched first. The field conditions having queried in the past and the satisfied field records are regarded as cache records and stored in the cache levels. By adopting appropriate cache record replacement and lock mechanism, the cache records that are active frequently or recently are searched first. Consequently, the speed for retrieving the past query results from a database can be accelerated.

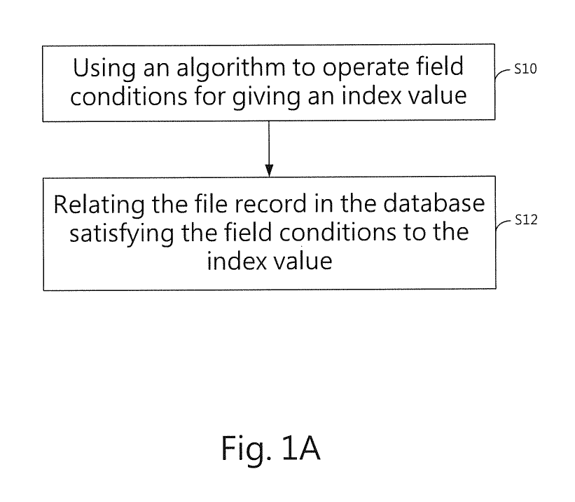

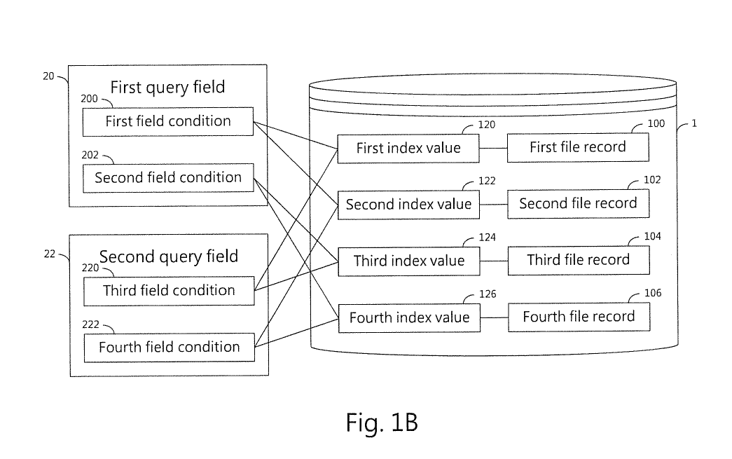

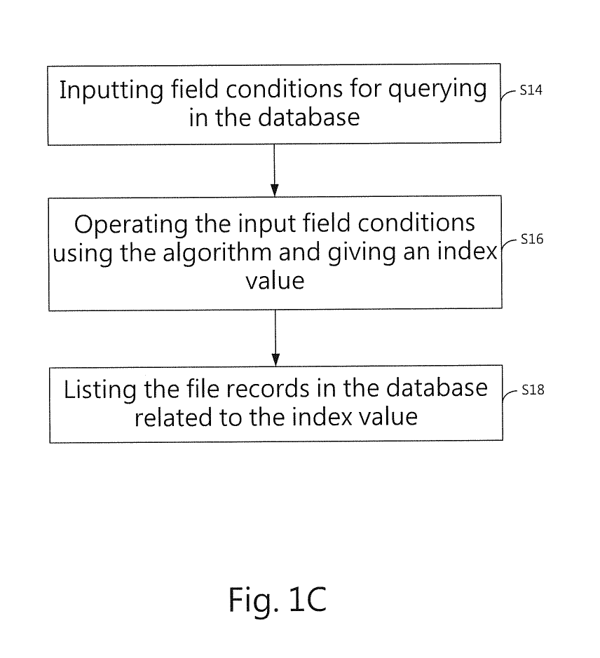

Please refer to FIGS. 1A to 1C, which show a flowchart for building database, a structural schematic diagram of the database, and a flowchart for querying in a database according to a first embodiment of the present invention. As shown in FIG. 1A, the method for building database according to the present invention comprises the main steps of:

Step S10: Using an algorithm to operate field conditions for giving an index value; and

Step S12: Relating the file record in the database satisfying the field conditions to the index value.

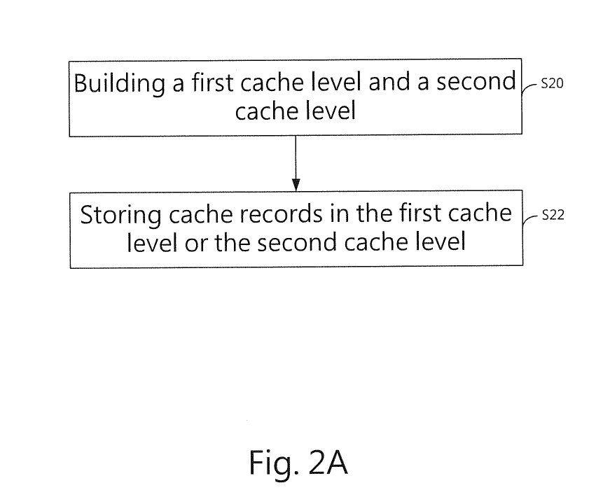

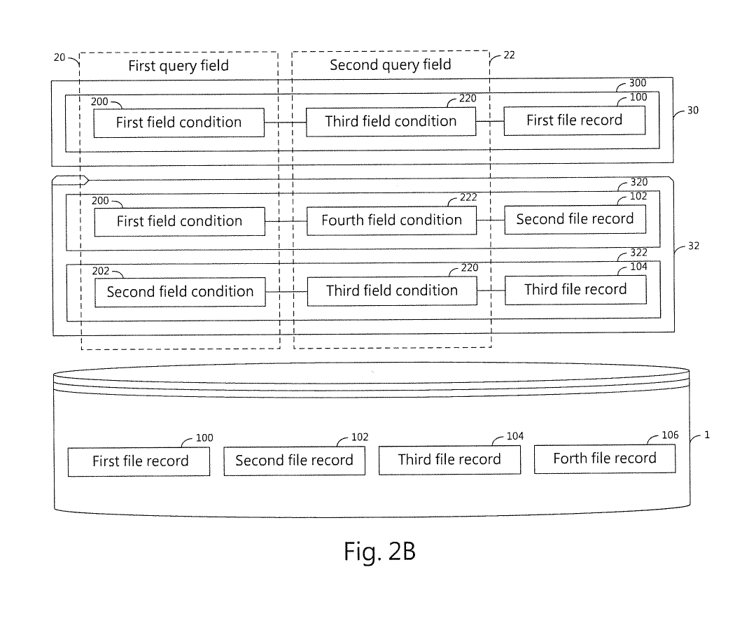

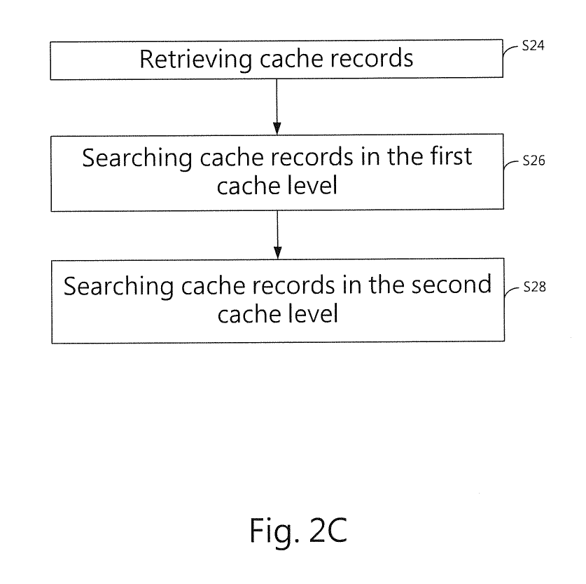

As shown in FIG. 2B, a database 1 in the method for building database according to the present invention comprises a plurality of file records, including a first file record 100, a second file record 102, a third file record 104, and a fourth file record 106. The plurality of file records can be queried by inputting the field conditions of a first query field 20 and a second query field 22, respectively, for querying. A first field condition 200 or a second field condition 202 can be input to the first query field 20; a third field condition 220 or a fourth field condition 222 can be input to the second query field 22.

In the step S10, by using an algorithm, the first field condition 200 and the third field condition 220 can be mixed and operated to give a first index value 120; the first field condition 200 and the fourth field condition 222 can be mixed and operated to give a second index value 122; the second field condition 202 and the third field condition 220 can be mixed and operated to give a third index value 124; and the second field condition 202 and the fourth field condition 222 can be mixed and operated to give a fourth index value 126. The first, second, third, and fourth index values 120, 122, 124, 126 are also contained in the database 1.

The algorithm can be a hash algorithm for example, an MD5 algorithm. The plurality of index values given by the operation according to the algorithm can be UUIDs, respectively. By using the plurality of UUIDs, the plurality of file records satisfying the corresponding plurality of query conditions can be searched.

In the step S12, the first file record 100 satisfies the first and third field conditions 200, 220 and hence be related to the first index value 120; the second file record 102 satisfies the first and fourth field conditions 200, 222 and hence be related to the second index value 122; the third file record 104 satisfies the second and third field conditions 202, 220 and hence be related to the third index value 124; and the fourth file record 106 satisfies the second and fourth field conditions 202, 222 and hence be related to the fourth index value 126. The relationship between the plurality of file records and the plurality of index values is recorded in the database 1.

The plurality of index values can be used as new field data of the file records satisfying the corresponding plurality of query conditions. Thereby, while querying, the index values stored in these new fields in respective file records can be compared.

By disposing the devices as described above and embodying the steps S10 and S12, the method for building database according to the present invention can mix and operate the field conditions of the query fields using the algorithm and giving the index values, which are used for searching the file records satisfying the field conditions. Thereby, the file record in the database acquired by comparing multiple query fields originally can be given by searching using only one index value. Accordingly, queries in the database using multiple field conditions can be accelerated.

As shown in FIG. 1C, the method for querying in a database according to the present invention can be applied to the database 1 shown in FIG. 1B built according to the method for building database shown in FIG. 1A, and comprises the main steps of:

Step S14: Inputting field conditions for querying in the database;

Step S16: Operating the input field conditions using the algorithm and giving an index value; and

Step S18: Listing the file records in the database related to the index value.

In the step S14, input the first or second field condition 200, 202 to the first query field 20 and the third or fourth field condition 220, 222 to the second query field 22, respectively, for querying the file records satisfying the plurality of input field conditions in the database 1.

In the step S16, by adopting the same algorithm in the step S10, the first or second field condition 200, 202 and the third or fourth field conditions 220, 222 input in the step S14 are mixed and operated to give the first, second, third, and fourth index values 120, 122, 124, 126.

In the step S18, according to the index values given in the step S16 and the relationship between the index values and the file records built in the step S12, the file records in the database 1 satisfying the plurality of field conditions input in the step S14 are listed and thus completing query of multiple field conditions.

By disposing the devices as described above and embodying the steps S14 and S18, the method for querying in a database according to the present invention can mix and operate the field conditions of the query fields using the algorithm and giving the index values, which are used for searching the file records satisfying the field conditions. The present invention provides an acceleration method for database using index value operation and mix-mode leveled cache to mix and operate a plurality of field conditions and give index values. Thereby, the file record in the database acquired by comparing multiple query fields originally can be given by searching using only one index value. Accordingly, queries in the database using multiple field conditions can be accelerated and the performance of querying multiple field conditions can be improved.

Please refer to FIGS. 2A to 2C, which show a flowchart for building database, a structural schematic diagram of the database, and a flowchart for querying in a database according to a second embodiment of the present invention. As shown in FIG. 2A, the method for building database according to the present invention comprises the main steps of:

Step S20: Building a first cache level and a second cache level; and

Step S22: Storing cache records in the first cache level or the second cache level.

As shown in FIG. 2B, a database 1 in the method for building database according to the present invention comprises a first cache level 30 and a second cache level 32. The data storage capacity of the second cache level 32 is greater than that of the first cache level 30. The first cache level 30 stores a first cache record 300; the second cache level 32 stores a second cache record 320 and a third cache record 322.

In the step S20, build the first and second cache levels 30, 32. The first cache level 30 is a memory cache; the second cache level 32 is a data table of the database 1.

The step S22 is executed for multiple times for storing the first cache record to the first cache level 30 and the second cache record 320 to a third cache level 322 and the second cache level 32.

According to the present embodiment, the plurality of cache records are the field conditions used before in multiple-field queries and the given file records by searching. As shown in FIG. 2B, the database 1 comprises a plurality of file records, including a first file record 100, a second file record 102, a third file record 104, and a fourth file record 106. The plurality of file records can be queries by inputting the field conditions of a first query field 20 and a second query field 22, respectively.

In a multiple-field query, a first field condition 200 is input to the first query field 20 and a third field condition 220 is input to the second query field 22. Then the first file record 100 satisfying the first and third field conditions 200, 220 is searched in the database 1. Next, the relationship among the first field condition 200, the third field condition 220, and the first file record 100 is used as the first cache record 300 and stored in the first cache level 30.

In another multiple-field query, a first field condition 200 is input to the first query field 20 and a fourth field condition 222 is input to the second query field 22. Then the second file record 102 satisfying the first and fourth field conditions 200, 222 is searched in the database 1. Next, the relationship among the first field condition 200, the fourth field condition 222, and the second file record 102 is used as the second cache record 320 and stored in the second cache level 32.

In still another multiple-field query, a second field condition 202 is input to the first query field 20 and a third field condition 220 is input to the second query field 22. Then the third file record 104 satisfying the second and third field conditions 202, 220 is searched in the database 1. Next, the relationship among the second field condition 202, the third field condition 220, and the third file record 104 is used as the third cache record 322 and stored in the second cache level 32.

By disposing the devices as described above and embodying the steps S20 and S22, the method for building database according to the present invention can use the field conditions ever used in multiple-field-condition queries and the given file records by past searching as cache records and stored in the built cache levels. When a multiple-field-condition query using the same field conditions is performed again, the cache record can be retrieved from the cache levels and thus giving the result of the multiple-field-condition query rapidly.

As shown in FIG. 2C, the method for querying in a database according to the present invention can be applied to the database 1 shown in FIG. 2B built according to the method for building database shown in FIG. 2A, and comprises the main steps of:

Step S24: Retrieving cache records;

Step S26: Searching cache records in the first cache level; and

Step S27: Searching cache records in the second cache level.

In the step S24, if the query in the database 1 has ever been performed, the query is equivalent to retrieving a cache record from the first or second cache level 30, 32. The cache record includes the present field conditions identical to those used before and the file records satisfying the field conditions.

As described above, if the first and third field conditions 200, 220 are input for query, the first cache record 300 is retrieved; if the first and fourth field conditions 200, 222 are input for query, the second cache record 320 is retrieved; and if the second and third field conditions 202, 220 are input for query, the third cache record 322 is retrieved.

In the method for querying in a database according to the present invention, searching the cache records is performed sequentially from the cache level having smallest data storage capacity to the one having the greatest. Thereby, in the step 826, the cache records, retrieved in the step S24, of the first cache level 30 having smaller data storage capacity are searched first.

If the first and third field conditions 200, 220 are used for querying and the first cache record 300 is retrieved, the first cache record 300 can be searched in the first cache level 30 in the step S26. In addition, according to the first cache record 300, the first file record 100 is listed as the result of this multiple-field query.

If the first and fourth field conditions 200, 222 are used for querying and the second cache record 320 is retrieved, or if the second and third field conditions 202, 220 are used for querying and the third cache record 322 is retrieved, because the second and third cache records 320, 322 are not stored in the first cache level 30, the second and third cache records 320, 322 cannot be searched in the first cache level 30. Then the step S28 has to be executed for searching the cache record retrieved in the step S24 in the second cache level 32. Next, according to the second or third cache record 320, 322, the second or third file record 102, 104 is listed as the result of this multiple-field query.

By disposing the devices as described above and embodying the steps S24 to S28, the method for querying in a database according to the present invention can record the field conditions used in past multiple-field-condition queries and the searched file records as cache record in the respective built cache levels. The cache records of the cache level having the smallest data storage capacity is searched first. By means of the cache records, the results of multiple-field-condition queries can be thus given rapidly. By arranging and storing the multiple-field queries queried more frequently or having close query times in the cache levels having smaller data storage capacity, the time required for searching the cache can be further saved.

Moreover, because the data storage capacity of respective cache level is fixed, an appropriate cache record replacement policy, for example, the round-robin queue algorithm, the LRU algorithm, and the LFU algorithm, is also adopted. Thereby, the cache records having frequent or recent queries are arranged to be stored in the cache levels having lower data storage capacity. In addition, in order to avoid fault replacement result of cache records during cache record replacement due to competition, the present invention can use the global or individual lock technique, along with the action of cache record replacement, for locking the cache records should not be replacement.

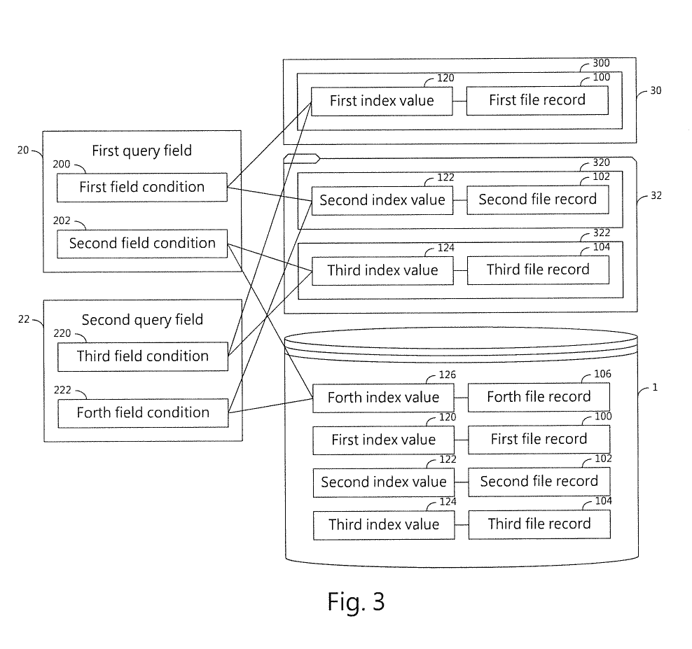

Please refer to FIG. 3, which shows a structural schematic diagram of the database according to a third embodiment of the present invention. As shown in the figure, by using the two methods for building a database disclosed in the present invention, a database 1 shown in FIG. 3 can be built. The database 1 comprises a plurality of file records, including a first file record 100, a second file record 102, a third file record 104, and a fourth file record 106. The database 1 also includes a first cache level 30 and a second cache level 32. Besides, the data storage capacity of the second cache level 32 is greater than that of the first cache level 30.

A first field condition 200 or a second field condition 202 can be input to the first query field 20; a third field condition 220 or a fourth field condition 222 can be input to the second query field 22. An algorithm is used to operate the plurality of field conditions and give a plurality of index values, which are further related to the file records satisfying the plurality of field conditions.

By using the algorithm, the first and third field conditions 200, 220 give a first index value 120, which is further related to the first file record 100 satisfying the first and third filed conditions 200, 220. By using the algorithm, the first and fourth field conditions 200, 222 give a second index value 122, which is further related to the second file record 102 satisfying the first and fourth filed conditions 200, 222. By using the algorithm, the second and third field conditions 202, 220 give a third index value 124, which is further related to the third file record 104 satisfying the second and third filed conditions 202, 220. By using the algorithm, the second and fourth field conditions 202, 222 give a fourth index value 126, which is further related to the fourth file record 106 satisfying the second and fourth field conditions 202, 222.

If the first and third field conditions 200, 220 are queried in the past, the first index value 120 given by operating the first and third field conditions 200, 220 and the first file record 100 related to the first index value 120 are used as a first cache record 300 and stored in the first cache level 30. If the first and fourth field conditions 200, 222 are queried in the past, the second index value 122 given by operating the first and fourth field conditions 200, 222 and the second file record 102 related to the second index value 122 are used as a second cache record 320 and stored in the second cache level 32. If the second and third field conditions 202, 220 are queried in the past, the third index value 124 given by operating the second and third field conditions 202, 220 and the third file record 104 related to the third index value 124 are used as a third cache record 322 and stored in the second cache level 32.

While querying the database 1 built according to the present embodiment, the field conditions are mixed and operated using the algorithm to give the index value. Then the cache record having the index value is searched starting from the cache level having the smallest data capacity. From the cache record, the file record corresponding to the index value is given. In each query, a new cache record will be added or the storage location of the cache record will be altered. Consequently, the cache records of the queries frequently or recently made are easier to be searched, hence optimizing the performance of database query.

To sum up, according to the acceleration method for database using index value operation and mixed-mode leveled cache of the present invention, index values are generated by operating a plurality of field conditions using an algorithm while building a database. The index values are further related to the file records satisfying the field conditions. Thereby, while querying using a plurality of field conditions, the file records satisfying the field conditions can be give rapidly by means of the index values. Furthermore, according to the present invention, a plurality of cache levels (pyramidal multi-level cache) can be built while building a database. The field condition queried in the past and the resultant file records are stored in the cache levels as cache records. While querying, the cache level having the smallest data storage capacity is searched first for the cache record. In addition, the frequently used or recently built cache records are first stored in the cache level having the smallest data storage capacity. As a consequently, the performance of retrieving cache data is improved and the required query time is shortened as well.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for building database, comprising steps of:
using an algorithm to operate a plurality of field conditions for giving an index value; and
relating at least a file record in a database satisfying said plurality of field conditions to said index value.

2. The method for building database of claim 1, wherein said algorithm is a hash algorithm.

3. The method for building database of claim 2, wherein said hash algorithm is a message-digest algorithm 5 (MD5) algorithm.

4. The method for building database of claim 1, wherein said index value is a universally unique identifier (UUID).

5. A method for building database, comprising steps of:
inputting a plurality of field conditions for querying in a database;
operating said plurality of input field conditions using said algorithm and giving an index value; and
listing at least a file record in said database related to said index value.

6. The method for building database of claim 5, wherein said algorithm is a hash algorithm.

7. The method for building database of claim 6, wherein said hash algorithm is a message-digest algorithm 5 (MD5) algorithm.

8. The method for building database of claim 5, wherein said index value is a universally unique identifier (UUID).

9. A method for building database, comprising steps of:
building a first cache level and a second cache level, the data storage capacity of said second cache level greater than the data storage capacity of the first cache level; and
storing a plurality of cache records in said first cache level or said second cache level.

10. The method for building database of claim 9, wherein said first cache level or said second cache level is a memory cache or a data table.

11. The method for building database of claim 9, wherein said plurality of cache records include a plurality of field conditions and at least a file record satisfying said plurality of field conditions.

12. The method for building database of claim 11, wherein said plurality of field conditions are operated according to an algorithm and giving an index value.

13. A method for querying in a database, comprising steps of:
retrieving a cache record;
searching said cache record in a first cache level; and
searching said cache record in a second cache level if said cache record is not stored in said first cache level, and the data storage capacity of said second cache level greater than the data storage capacity of said first cache level.

14. The method for querying in a database of claim 13, wherein said first cache level or said second cache level is a memory cache or a data table.

15. The method for querying in a database of claim 13, wherein said cache record includes a plurality of field conditions and at least a file record satisfying said plurality of field conditions.

16. The method for querying in a database of claim 15, wherein said plurality of field conditions are operated according to an algorithm and giving an index value.
